(19) United States
(12) Patent Application Publication
(10) Pub. No.: US 2009/0101568 A1
(43) Pub. Date: Apr. 23, 2009

(54) Device for coupling to equipment for treating water in general and waste water

(76) Inventors: Enric Palacios Donaque, Tordera (ES); Manuel Farinas Iglesias, Algorta (ES); Manuel Palomino Schatzlein, Valldoreix (ES)

Correspondence Address: KLAUBER & JACKSON, 411 HACKENSACK AVENUE, HACKENSACK, NJ, 07601, US

(21) Appl. No.: 12/284,613

(22) Filed: Sep. 23, 2008

Related U.S. Application Data
(63) Continuation of application No. PCT/ES2006/000275, filed on May 23, 2006.

(51) Int. Cl. B01D 24/30; B01D 24/46

(52) U.S. Cl. 210/288

(57) ABSTRACT

The equipment incorporates a tank that contains a moving bed of sand and inside which there is the device of the invention, which comprises a tubular pumping device associated with a space coaxial with an inlet conduit for the water to be treated and with outlets for said water within the bed of sand, including a sand washer placed in the upper part of the pumping structure, and also an outlet conduit for clean water and an outlet conduit for dirty water. Novelty focuses on the tubular pumping structure, which includes a fluidizing nozzle and also a lateral injection of air, with the interposition of a laminar filtering body.

### RELATED APPLICATION

The present application is a Continuation of co-pending PCT Application No. PCT/ES2006/000275, filed May 23, 2006. Applicants claim the benefits of 35 U.S.C. §120 as to the PCT application, and the entire disclosure of said application is incorporated herein by reference in its entirety.

### OBJECT OF THE INVENTION

As stated in the title of this descriptive specification, the following invention relates to a device for pumping water, waste water and water with solids, whose main application is in filters that incorporate a filtering sand bed located inside a tank, filtering in the ascending direction. The pumping device raises water and solids by means of injection of air and, via a vertical pipe, part of the dirty water together with sand impregnated with dirt is raised as high as an upper washer where that sand is thoroughly cleaned and it again falls on the free surface of the sand bed, while the dirty water with solids is evacuated to the outside through a radial outlet of the tank.

The water to treat is introduced inside the sand bed via a coaxial pipe with the vertical pumping pipe.

Most of the water filtered in the sand bed ascends upwards leaving the dirt in that sand, primarily in the lower part of the bed. This filtered water ascends above the level of the sand bed until it reaches a radial outlet from the tank for collecting that clean water.

The pumping of the dirty sand is done by means of injection of air into the lower part of the pumping conduit which provides a suction and impulsion effect for the dirty sand together with part of the dirty water from the lower zone of the sand bed, via the central pumping pipe.

Starting from this premise, a first objective of the invention is to improve the injection of air in order to prevent blockages and malfunctioning of the device of the invention, also succeeding in improving the removal of the dirt impregnated in the sand which ascends through the pumping pipe.

Another objective of the invention is the incorporation of a fluidizing nozzle also in order to prevent blockages in the equipment and also to achieve the removal of particles of dirt stuck to the sand which ascends through the pumping pipe.

### BACKGROUND OF THE INVENTION

There currently exists equipment for the treatment of water in order to clean it, such as for example Invention Patent with publication number in Spain 2220770, which incorporates a sand bed contained in a tank, inside which is also a system for pumping or decanting of that sand with sludge, water or mixture of these substances.

This pumping system drives solids mixed with dirty water. In general, these solids consist of sand. The pumping action is carried out by injected air.

The devices currently known present certain problems, such as obstruction of the air conduit and obstruction of the conduit for suction of the mixture of solid and water.

These pumping systems are mostly used in the ascending direction in moving bed sand filters.

In these filters, the pumping of the sand from the lower part of the filter causes that sand to be raised up towards the upper part by the action of air, where there is a device for the washing of that sand.

Moreover, this filtering system is much used in the treatment of drinking water in order to eliminate suspended solids and reduce the turbidity of the water.

When the technique of coagulation is used on those filters (contact coagulation) by means of iron or aluminum salts or any organic coagulant, the problem usually arises of the obstruction of the suction conduit of the pumping system via a tubular structure due to the drop in fluidity of the sand owing to the mixture of it with the flocs formed in the coagulation process.

On the other hand, one of the problems that usually appears in this type of pump when they are used in sand filtering systems is the blockage of the air inlet holes caused by the sand itself when it enters the pumping system, which fundamentally consists of a tubular structure.

### SUMMARY OF THE INVENTION

With the aim of achieving the objectives and avoiding the drawbacks mentioned above, the invention proposes a device for treatment of water and waste water characterized in that the system for pumping sand and dirty water through the tubular suction or impulsion system incorporates a porous laminar body through which air is injected in order to avoid blockages.

Another characteristic of the invention is that the inside of this porous body contains a lateral air chamber arranged in correspondence with at least a radial portion of the tubular pumping structure (suction and impulsion), though it will normally cover a complete annular surface of 360°.

Another characteristic of the invention relates to the incorporation of a water injection nozzle which will essentially be arranged in the lower opening of the tubular pumping structure, in such a way that fluidization is thus achieved of the sand, flocs and sludges, preventing obstruction of that pumping tube in its lower part.

The tubular pumping structure is characterized in that it comprises a set of air injection nozzles and a set of water injection nozzles, both sets being associated by means of an intermediate tube, there existing another upper tube which connects with the upper part of the set of air injection nozzles. Arranged around this upper tube is a conventional washer for dirty sand which rises through the interior part of the tubular pumping structure together with the dirty water.

It is important to highlight the fact that the distance between the sets of nozzles can be regulated by adjusting the distance of the union rods.

The tubular pumping structure is located inside a conventional tank which contains the moving sand bed, the sand being the material that actually carries out the filtering and cleaning of the water to treat, with the dirt remaining stuck to the sand, in such a way that the lower part of the sand together with part of the dirty water will ascend thanks to the injection of air through the tubular pumping structure. During this ascension, owing to the mechanical agitation that is produced, the dirt separates from the sand, and the dirty water finally flows through an upper outlet conduit. In turn, the sand that has risen through the tubular pumping structure is completely cleaned in the upper washer which will return the clean sand to the sand bed.

Moreover, most of the water that enters inside the device will ascend upwards through the filtering of the sand, exceeding the free level of the sand bed, in order to then be discharged through an outlet conduit for clean water, with the dirt being retained in the sand, as has been mentioned.

The introduction of the water to treat is carried out via a conduit that leads to a space coaxial with the pumping structure, with this coaxial space leading to an outlet located inside the sand bed.

Below, in order to facilitate a better understanding of this descriptive specification and forming an integral part thereof, some figures are attached in which the object of the invention has been represented by way of illustration and non-limiting.

### BRIEF DESCRIPTION OF THE DRAWINGS

FIG. 1. —Shows a view in cross-section of the device for the pumping of water, waste water and water with solids, forming the object of the invention. Essentially standing out here is the tubular pumping structure that prevents blockages.

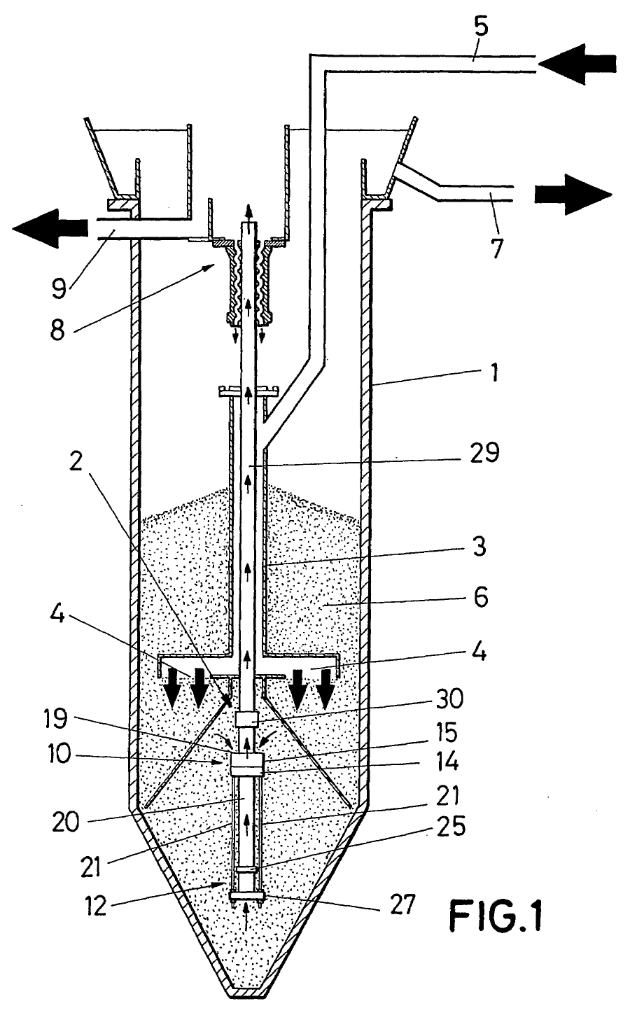

FIG. 2. —Shows a view in exploded perspective of the tubular pumping structure.

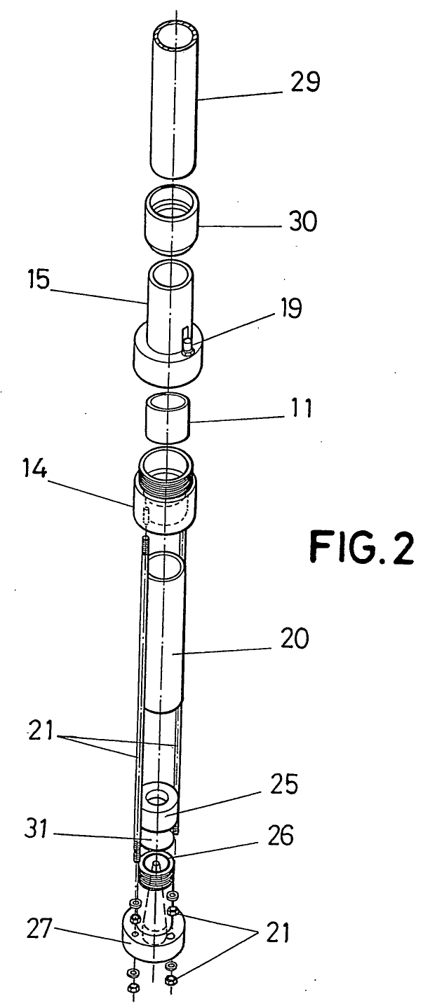

FIG. 3. —Shows a view in detail of an air injection nozzle and a water fluidizing nozzle, both forming part of the pumping structure.

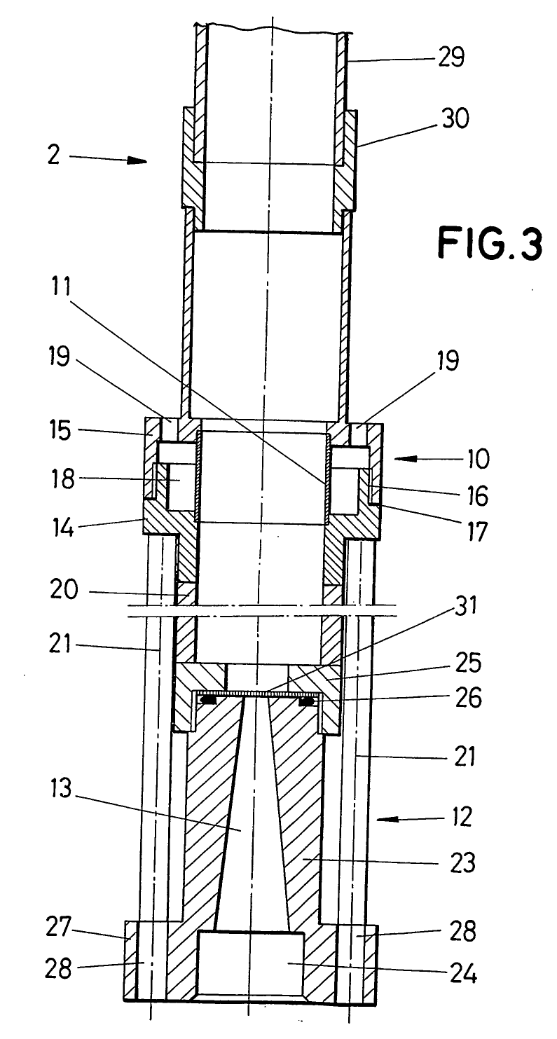

### DESCRIPTION OF THE PREFERRED FORM OF EMBODIMENT

Considering the numbering adopted in the figures, the equipment which the device of the invention incorporates is defined starting from a tank 1 which possesses a larger cylindrical portion with a closed lower termination having a conical shape. Arranged longitudinally in the center of the tank is a tubular pumping structure 2, around which there exists a coaxial space 3 which occupies a major part of the length of that tubular structure outside of it, said coaxial space leading to some radial outlet mouths 4 for the water to treat which is introduced via an upper conduit 5 which connects with the coaxial space 3, said radial mouths 4 being directed downwards.

The conical portion and a large part of the cylindrical portion of the tank 1 are occupied by a sandy material constituting the moving cleaning bed 6 for the water to treat.

Located within the sand bed 6 are the radial mouths 4 for the outlet of water to treat, previously introduced into the equipment, in such a way that most of this water will rise upward becoming filtered by the upper portion of the sand bed which is found above those radial mouths 4, such that the dirt from this ascending water will be retained in that portion of sand reaching the upper part of the tank 1, evidently above the free level of that sand bed 6, the upper part where there exists an outlet conduit 7 for that clean water.

Another part of the water to treat will be filtered through the bottom below the radial mouths 4, though dragging along its dirt, part of which will also be retained in the operation of the sand bed that lies below the radial outlet mouths 4.

In this situation, the sand bed 6 will be soaked with water, so that the soaking of the lower portion of the bed will facilitate the ascension of the greater part of the water via the upper portion of the sand bed.

Moreover, in the upper part of the pumping structure 2 and around it, there exists a conventional sand washer 8, in such a way that when the equipment is functioning the dirty sand rises little by little through the pumping structure from its lower end mixed with dirty water with the aid of an injection of air, in such a way that the mixture that rises through this pumping structure 2 is made up of air bubbles, dirty water and sand that is also dirty.

During this ascension, the sand in that ascending mixture undergoes mechanical agitation and vibration by means of the action of air bubbles, with a large part of the dirt becoming separated from the ascending sand. The complete cleaning of this sand is carried out in the washer 8, with the now clean sand falling afterwards onto the free surface of the sand bed 6.

On the other hand, the ascending dirty water which also includes all the remains of dirt that have become unstuck from the sand that is also rising, is evacuated to the outside via a lateral conduit 9.

As stated in the section on the description, the novelty of the invention is focused on the tubular pumping structure 2 which includes:
an air injection nozzle 10 which introduces the air laterally into that tubular structure 2 via a porous laminar body 11 arranged coaxially in order to prevent blockages and to facilitate the ascension of the mixture circulating inside the tubular pumping structure.
A fluidizing nozzle 12 with a conical throat 13 located in the lower end section of the tubular structure 2, this nozzle 12 facilitating the pumping and circulation of the ascending mixture formed by the dirty water and sand.

The air injection nozzle 10 consists in principle of a lower body 14 and an upper body 15, the two being joined by means of threading 16 with the interposition of a front sealing O-ring 17, with an intermediate chamber 18 being defined between both bodies where the porous laminar body 11 is fitted, and at the same time said internal chamber 18 is linked to the outside via some air inlet holes 19, these holes being found essentially in the upper body 15, in such a way that the air will pas to the interior of the tubular pumping structure 2 via said porous laminar body 11.

Connected to the lower body 14 of the air injection nozzle 10 is an intermediate tube 20 for suction of water, sand and dirt. The union of the lower body 14 and the nozzle 12 is carried out by means of longitudinal rods 21 and nuts 22 which permit the distance to be varied between said nozzles 10 and 12.

The fluidizing nozzle 12 includes a base body 23 which incorporates the conical throat 13 and a lower throat portion in cylindrical form 24, with a bent collar 25 being threaded in the upper part of that base body 23 and interposing a sealing joint 26 and a porous disc 31 in order to prevent the entry of sand and dirt into the hole where water is injected for the fluidization of the bed.

In turn, the base body 23 possesses an annular extension 27 with holes 28 for facilitating the connection of the two mouths 10 and 12 via the rods 21 which are introduced into said holes 28.

Moreover, connected to the upper body 15 of the air injection nozzle 10 is an upper tube 29 with the interposition of an adapter 30, the conventional sand washer 8 being coupled in the final section of this tube.

1. DEVICE FOR COUPLING TO EQUIPMENT FOR TREATING WATER IN GENERAL AND WASTE WATER, comprising a tank containing a moving bed of sand, a tubular pumping structure associated with a coaxial space with an upper conduit for entrance of water to be treated and with radial outlets for said water inside the bed of sand; the device further comprising a sand washer arranged in the upper part of the tubular pumping structure, an outlet conduit for clean water which starts from the wall of the tank and an outlet conduit for dirty water; ascending through the tubular structure there is a mixture made up of dirty water with sand and air bubbles, the mixture being driven by means of air injection which drives and pumps the mixture from the bottom upwards up to the washer which returns the clean sand to the moving bed of sand; wherein the air injection is carried out by means of an injection nozzle which introduces air through at least one side portion of the tubular pumping structure.

2. DEVICE FOR COUPLING TO EQUIPMENT FOR TREATING WATER IN GENERAL AND WASTE WATER, according to claim 1, wherein it incorporates a fluidizing nozzle with at least one conical throat, the fluidizing nozzle being located in the lower initial section of the tubular pumping structure.

3. DEVICE FOR COUPLING TO EQUIPMENT FOR TREATING WATER IN GENERAL AND WASTE WATER, according to claim 1, wherein a porous laminar body for filtering and distribution of air is inserted in the air injection into the tubular pumping structure.

4. DEVICE FOR COUPLING TO EQUIPMENT FOR TREATING WATER IN GENERAL AND WASTE WATER, according to claim 2, wherein a porous laminar body for filtering and distribution of air is inserted in the air injection into the tubular pumping structure.

5. DEVICE FOR COUPLING TO EQUIPMENT FOR TREATING WATER IN GENERAL AND WASTE WATER, according to claim 3, wherein the injection nozzle is inserted in the tubular pumping structure in such a way that an intermediate tube is connected beneath the injection nozzle, being the end of the intermediate tube free and at an adjustable distance from the end of the fluidizing nozzle, while the upper end of the air injection nozzle is connected to an upper tube with the interposition of an adapter, at the same time in the top section of the upper tube the sand washer is coupled.

6. DEVICE FOR COUPLING TO EQUIPMENT FOR TREATING WATER IN GENERAL AND WASTE WATER, according to claim 4, wherein the injection nozzle is inserted in the tubular pumping structure in such a way that an intermediate tube is connected beneath the injection nozzle, being the end of the intermediate tube free and at an adjustable distance from the end of the fluidizing nozzle, while the upper end of the air injection nozzle is connected to an upper tube with the interposition of an adapter, at the same time in the top section of the upper tube the sand washer is coupled.

7. DEVICE FOR COUPLING TO EQUIPMENT FOR TREATING WATER IN GENERAL AND WASTE WATER, according to claim 5, wherein the two nozzles are associated by means of longitudinal rods associated with nuts for being able to vary the relative distance between the two nozzles, inserting the intermediate tube.

8. DEVICE FOR COUPLING TO EQUIPMENT FOR TREATING WATER IN GENERAL AND WASTE WATER, according to claim 6, wherein the two nozzles are associated by means of longitudinal rods associated with nuts for being able to vary the relative distance between the two nozzles, inserting the intermediate tube.

9. DEVICE FOR COUPLING TO EQUIPMENT FOR TREATING WATER IN GENERAL AND WASTE WATER, according to claim 3, wherein the air injection nozzle comprises two bodies, lower and upper, joined together with the interposition of a sealing joint, with an air chamber being defined in the injection nozzle where the porous laminar filtering body is to be found and to which leads at least one inlet hole for the injection of pressure air which will reach the interior of the tubular pumping structure.

10. DEVICE FOR COUPLING TO EQUIPMENT FOR TREATING WATER IN GENERAL AND WASTE WATER, according to claim 4, wherein the air injection nozzle comprises two bodies, lower and upper, joined together with the interposition of a sealing joint, with an air chamber being defined in the injection nozzle where the porous laminar filtering body is to be found and to which leads at least one inlet hole for the injection of pressure air which will reach the interior of the tubular pumping structure.

11. DEVICE FOR COUPLING TO EQUIPMENT FOR TREATING WATER IN GENERAL AND WASTE WATER, according to claim 5, wherein the air injection nozzle comprises two bodies, lower and upper, joined together with the interposition of a sealing joint, with an air chamber being defined in the injection nozzle where the porous laminar filtering body is to be found and to which leads at least one inlet hole for the injection of pressure air which will reach the interior of the tubular pumping structure.

12. DEVICE FOR COUPLING TO EQUIPMENT FOR TREATING WATER IN GENERAL AND WASTE WATER, according to claim 6, wherein the air injection nozzle comprises two bodies, lower and upper, joined together with the interposition of a sealing joint, with an air chamber being defined in the injection nozzle where the porous laminar filtering body is to be found and to which leads at least one inlet hole for the injection of pressure air which will reach the interior of the tubular pumping structure.

13. DEVICE FOR COUPLING TO EQUIPMENT FOR TREATING WATER IN GENERAL AND WASTE WATER, according to claim 7, wherein the air injection nozzle comprises two bodies, lower and upper, joined together with the interposition of a sealing joint, with an air chamber being defined in the injection nozzle where the porous laminar filtering body is to be found and to which leads at least one inlet hole for the injection of pressure air which will reach the interior of the tubular pumping structure.

14. DEVICE FOR COUPLING TO EQUIPMENT FOR TREATING WATER IN GENERAL AND WASTE WATER, according to claim 8, wherein the air injection nozzle comprises two bodies, lower and upper, joined together with the interposition of a sealing joint, with an air chamber being defined in the injection nozzle where the porous laminar filtering body is to be found and to which leads at least one inlet hole for the injection of pressure air which will reach the interior of the tubular pumping structure.

15. DEVICE FOR COUPLING TO EQUIPMENT FOR TREATING WATER IN GENERAL AND WASTE WATER, according to claim 7, wherein the fluidizing nozzle comprises a base body which incorporates a conical throat along with an initial cylindrical throat portion, the base body further comprising an annular extension with holes (28) where the longitudinal rods are introduced, the fluidizing nozzle further comprising a bent collar coupled in the outlet of the base body with the interposition of a sealing joint and a porous disc.

16. DEVICE FOR COUPLING TO EQUIPMENT FOR TREATING WATER IN GENERAL AND WASTE WATER, according to claim 8, wherein the fluidizing nozzle comprises a base body which incorporates a conical throat along with an initial cylindrical throat portion, the base body further comprising an annular extension with holes (28) where the longitudinal rods are introduced, the fluidizing nozzle further comprising a bent collar coupled in the outlet of the base body with the interposition of a sealing joint and a porous disc.

17. DEVICE FOR COUPLING TO EQUIPMENT FOR TREATING WATER IN GENERAL AND WASTE WATER, according to claim 9, wherein the fluidizing nozzle comprises a base body which incorporates a conical throat along with an initial cylindrical throat portion, the base body further comprising an annular extension with holes (28) where the longitudinal rods are introduced, the fluidizing nozzle further comprising a bent collar coupled in the outlet of the base body with the interposition of a sealing joint and a porous disc.

18. DEVICE FOR COUPLING TO EQUIPMENT FOR TREATING WATER IN GENERAL AND WASTE WATER, according to claim 10, wherein the fluidizing nozzle comprises a base body which incorporates a conical throat along with an initial cylindrical throat portion, the base body further comprising an annular extension with holes (28) where the longitudinal rods are introduced, the fluidizing nozzle further comprising a bent collar coupled in the outlet of the base body with the interposition of a sealing joint and a porous disc.

19. DEVICE FOR COUPLING TO EQUIPMENT FOR TREATING WATER IN GENERAL AND WASTE WATER, according to claim 11, wherein the fluidizing nozzle comprises a base body which incorporates a conical throat along with an initial cylindrical throat portion, the base body further comprising an annular extension with holes (28) where the longitudinal rods are introduced, the fluidizing nozzle further comprising a bent collar coupled in the outlet of the base body with the interposition of a sealing joint and a porous disc.

20. DEVICE FOR COUPLING TO EQUIPMENT FOR TREATING WATER IN GENERAL AND WASTE WATER, according to claim 12, wherein the fluidizing nozzle comprises a base body which incorporates a conical throat along with an initial cylindrical throat portion, the base body further comprising an annular extension with holes (28) where the longitudinal rods are introduced, the fluidizing nozzle further comprising a bent collar coupled in the outlet of the base body with the interposition of a sealing joint and a porous disc.

21. DEVICE FOR COUPLING TO EQUIPMENT FOR TREATING WATER IN GENERAL AND WASTE WATER, according to claim 13, wherein the fluidizing nozzle comprises a base body which incorporates a conical throat along with an initial cylindrical throat portion, the base body further comprising an annular extension with holes (28) where the longitudinal rods are introduced, the fluidizing nozzle further comprising a bent collar coupled in the outlet of the base body with the interposition of a sealing joint and a porous disc.

22. DEVICE FOR COUPLING TO EQUIPMENT FOR TREATING WATER IN GENERAL AND WASTE WATER, according to claim 14, wherein the fluidizing nozzle comprises a base body which incorporates a conical throat along with an initial cylindrical throat portion, the base body further comprising an annular extension with holes (28) where the longitudinal rods are introduced, the fluidizing nozzle further comprising a bent collar coupled in the outlet of the base body with the interposition of a sealing joint and a porous disc.
